(19) United States
(12) Patent Application Publication
(10) Pub. No.: US 2016/0356664 A1
(43) Pub. Date: Dec. 8, 2016

(54) PRESSURE MEASURING DEVICE

(71) Applicant: VALEO SYSTEMES DE CONTROLE MOTEUR, Cergy Saint Christophe (FR)

(72) Inventors: Piotr Zakrzewski, Acheres (FR); Nicolas Gelez, Le Pecq (FR)

(73) Assignee: Valeo Systemes de Controle Moteur, Cergy Saint Christophe (FR)

(21) Appl. No.: 15/109,145

(22) PCT Filed: Dec. 19, 2014
(86) PCT No.: PCT/FR2014/053451

§ 371 Date: Aug. 23, 2016

(30) Foreign Application Priority Data
Dec. 31, 2013 (FR) 1363750

(51) Int. Cl. G01L 19/14; G01L 19/06; G01L 9/00

(52) U.S. Cl. CPC G01L 19/148; G01L 9/0075; G01L 19/0672; G01L 9/0051

(57) ABSTRACT

The present invention relates to a device for measuring an outside pressure, comprising:
a pressure sensor comprising a support (14) and a ceramic membrane (16) mounted on the support so as to undergo deformation under the effect of a change in the outside pressure, and
a measurement circuit comprising a strain gauge fastened to the ceramic membrane so as to have an electrical property that is variable depending on the position of said membrane, and an electronic component electrically connected to said strain gauge and configured for processing a signal received from said strain gauge,
   the device being characterized in that the electronic component is fastened to the support.

### TECHNICAL FIELD

The invention relates to a pressure measurement device, used in particular in a motor vehicle.

### PRIOR ART

A pressure measurement device conventionally comprises a pressure sensor and a measurement circuit. The pressure sensor conventionally comprises, depending on the use, a support and a ceramic membrane mounted on the support so as to undergo deformation due to the effect of the ambient pressure. The measurement circuit conventionally comprises a strain gauge fastened to the ceramic membrane, and an offset electronic component electrically connected to the strain gauge. The strain gauge is arranged on the ceramic layer so as to have an electrical property, for example, a resistance, that is variable depending on the position of said membrane. The electronic component is configured for processing a signal received from said strain gauge in order to provide an evaluation of the corresponding pressure.

In the field of automobile electronics, there is a continual need for a pressure measurement device that is more compact and less expensive to manufacture.

An aim of the present invention is to meet this need, at least partially.

### SUMMARY OF THE INVENTION

According to the invention, this aim is achieved by means of a device for measuring an outside pressure, comprising:

a pressure sensor comprising a support and a ceramic membrane mounted on the support so as to undergo deformation under the effect of a change in the outside pressure, and

a measurement circuit comprising a strain gauge fastened to the ceramic membrane so as to have an electrical property that is variable depending on the position of said membrane, and an electronic component electrically connected to said strain gauge and configured for processing a signal received from said strain gauge.

According to the invention, the electronic component is fastened to the support.

As will be seen in further detail in the remainder of the description, the support is thus used to fasten both the membrane and the electronic component. The measurement device is therefore more compact. In addition, it comprises a reduced number of parts, which limits its manufacturing cost.

A measurement device according to the invention can additionally comprise one or more of the following optional features:

the measurement device comprises a connection pin connected to the support by a flexible connector,

the flexible connector is selected from a spring, in particular a coil spring, a wire and a resilient tongue,

said flexible connector ensures an electrical connection between said electronic component and said pin,

said flexible connector is a coil spring,

said flexible connector is coated with a gold layer,

a sublayer of nickel extends under the gold layer,

the support is made of a ceramic material,

the pressure sensor comprises a glass layer protecting, preferably insulating, said ceramic membrane from the outside,

the support comprises a cavity in which the ceramic membrane can undergo deformation,

the support and the ceramic membrane together define a leak-proof internal chamber,

the ceramic membrane is suitable for measurements of a pressure between 0 and 300 bar,

the processing includes a transformation of the signal or a filtering, for example, in order to ensure electromagnetic protection.

The invention also relates to a measurement device according to the invention for a motor vehicle.

The invention also relates to an apparatus comprising a measurement device according to the invention, said apparatus being preferably selected from the group consisting of an engine, in particular a heat engine, a transmission, a braking device, an air conditioner, a refrigerator, and a freezer. The pressure sensor can be, for example, in contact with oil, for example, if the apparatus is a transmission or engine, or with a refrigerant fluid, for example, if the apparatus is selected from an air conditioner, a freezer, and a refrigerator, or with a brake fluid if the apparatus is a braking device. A measurement device according to the invention can be used, in particular, in the context of control and/or can ensure safety functions.

Finally, the invention relates to a motor vehicle provided with an apparatus according to the invention.

### BRIEF DESCRIPTION OF THE FIGURES

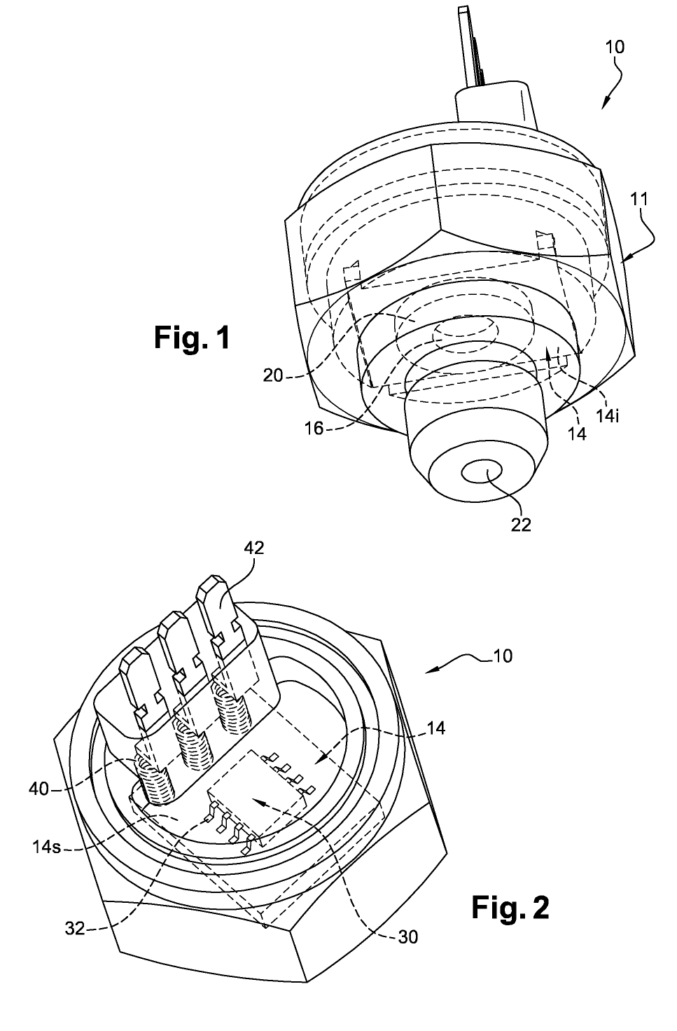

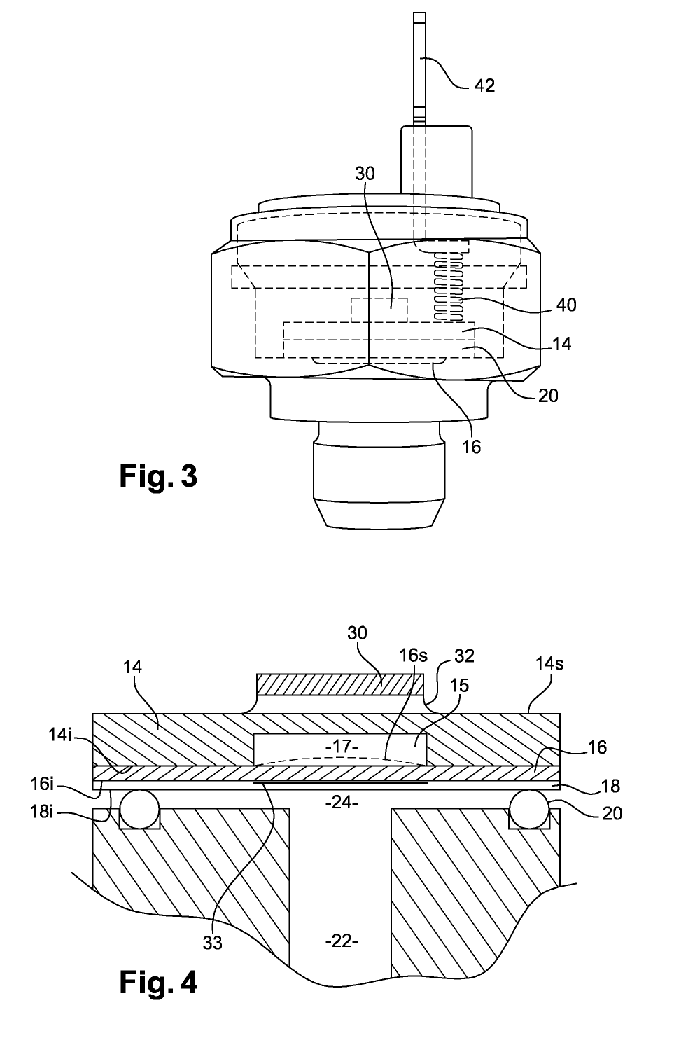

Other features and advantages of the present invention will become apparent upon reading the following detailed description and examining the appended drawing in which the figures represent in a perspective and transparent view (FIGS. 1 to 3), or partially in a diagrammatic cross section (FIG. 4), an embodiment of a measurement device according to the invention.

### DEFINITIONS

The adjectives “upper” and “lower” are used, in a non-limiting manner, with regard to the position of the device represented in FIG. 1 or in FIG. 4.

Unless otherwise indicated, “comprising a” or “including a” is understood to mean “comprising at least one.”

### DETAILED DESCRIPTION

As represented in the figures, a pressure measurement device 10 according to the invention comprises a casing 11, as well as a pressure sensor and a measurement circuit which are housed in the casing 11.

The pressure sensor comprises a support 14 and a membrane 16 made of a ceramic material.

The support 14 is a small plate having a substantially constant thickness, which has a substantially rectangular shape seen from the front. It has an upper surface 14s and a lower surface 14i.

The thickness of the support is preferably between 1 and 5 mm. The width of the support is preferably between 8 and 16 mm. The length of the support is preferably between 10 and 20 mm.

The support 14 can be made of a material selected from the ceramic materials, and preferably from the alumina powder-based ceramic materials, and, for example, a monolithic ceramic.

Preferably, the support 14 is in the form of one piece.

The lower surface 14i preferably has a cavity 15, which is preferably circular cylindrical, in which the membrane 16 can undergo deformation under the effect of an increase in the outside pressure.

The substantially flat, preferably discoid, membrane 16 has an upper surface 16s and a lower surface 16i.

The membrane 16 can be made of a material selected from the ceramic materials, and preferably from the alumina powder-based ceramic materials, and, for example, a monolithic ceramic.

The membrane 16 preferably has a thickness between 0.15 and 0.4 mm.

Preferably, the membrane 16 is insulated from the outside by a glass layer 18, which protects it from the outside environment while enabling its deformation under the effect of the outside pressure. Preferably, the glass layer extends over a portion of the surface of the membrane 16 and thus defines a surface in contact with the outside pressure to be measured.

The edge of the membrane 16 is sealingly fastened, for example, glued, to the lower surface 14i of the support. The membrane 16 closes the cavity 15 so as to define with the support a leak-proof internal chamber 17 that is sealed with respect to the fluid whose pressure one is trying to measure, in which an “internal pressure” prevails. The upper surface 16s of the membrane 16 is thus exposed to said internal pressure.

The membrane is also in contact, on another surface, with an annular weather strip 20 that ensures the sealing of the device. The weather strip 20 preferably has a thickness greater than 1.5 mm so as to keep the membrane 16 apart from the lower surface 14i of the support 14, thus allowing its free deformation under the effect of the outside pressure. The sealing function is ensured by the compression of the weather strip.

The weather strip 20 can be integral with the support 14.

The weather strip 20 can be made, for example, of a material whose chemical composition can vary as a function of the targeted fluid and of the compression forces that are acceptable and necessary for guaranteeing the sealing. The material can thus be selected from the elastomers, and, for example, hydrogenated nitryl rubber or the acrylic elastomers.

The assembly is configured in such a manner that the force generated by the weather strip during its compression does not deform the membrane and thus does not falsify the measurement.

The casing 11 defines a duct 22 that puts the outside and the lower surface 18i of the glass layer 18 (or, if this glass layer is absent, the lower surface 16i of the membrane 16) in fluidic communication, so that said membrane is exposed to the ambient pressure or “outside pressure.”

Preferably, the measurement device comprises a gasket or weather strip 20, inserted sealingly between the casing 11, on the one hand, and the support 14 or the glass layer 18, as represented, or the membrane 16, on the other hand, in order to define an outer chamber 24 into which the duct 22 leads.

Due to the effect of a variation of the outside pressure, the membrane 16 can thus undergo deformation, by bending, like a skin fastened to a drum.

The cross section of the passage of the duct 22 is conventionally between 1.5 and 5 mm.

The measurement circuit comprises an electronic component 30 fastened by tabs 32 to the upper surface 14s of the support 14 opposite the lower surface 14i. The electronic component 30 is electrically connected to a strain gauge 33 fastened to the membrane 16, so that an electric current can circulate between the electronic component 30 and said strain gauge.

A strain gauge has the particular feature of having an electrical property, for example, an electrical resistance or an electrical capacitance, that depends on its geometry. In particular, when it is fastened to a membrane capable of undergoing deformation, its geometry can vary under the effect of this deformation.

The electronic component 30 can be configured, in particular, for transforming the electrical signal coming from the strain gauge 33 into information corresponding to the outside pressure that led to the deformation of said strain gauge. It can also be configured for ensuring a processing of this signal, in order to electromagnetically protect the environment of the measurement device.

The measurement circuit also comprises three coil springs 40 (not represented in FIG. 4) abutting against the upper surface 14s of the support, tracks, not shown, ensuring an electrical connection between each of the springs 40 and the electronic component 30. The free end of a spring 40 is fastened to a pin 42 which in turn is fastened to the casing 11, and which protrudes from said casing 11. The pins 42 enable a connection with an outside electrical apparatus, for example, in order to ensure a supply of power to the measurement device and/or communication of the results of the measurement to the outside.

Preferably, the electrical connection between a pin 42 and a tab 32 of the electronic component 30 is ensured exclusively by the springs and possibly by tracks running on the upper surface of the support 14.

Preferably, a spring 40 is covered with a nickel sublayer which in turn is covered by a gold layer. Advantageously, it is thus possible to limit and even avoid corrosion by reinforcement and to guarantee satisfactory electrical conductivity.

Flexible connectors other than a spring 40 can be considered for establishing the electrical connection between a pin 42 and the electronic component 30, for example, a leaf spring or a wire. The flexible connector can also assume the shape of resilient tongues.

The use of a flexible connector advantageously makes it possible to absorb the difference in thermal expansion between the support 14, which is preferably made of a ceramic material, and the pins 42, conventionally made of metal, and thus limits the risk of breaking the electrical connection.

Advantageously, a measurement device according to the invention is particularly well suited in applications in which it is exposed to vibrations and temperature variations, and, in particular, in automobile applications in which it can be exposed to temperatures varying between −40° C. and +160° C. In particular, a welding would poorly resist such temperature variations.

A measurement device according to the invention can be used, in particular, in an oil pressure sensor of a transmission, in an air conditioner, a freezer or a refrigerator, in order to measure the pressure of the refrigerant fluid, in a braking device, in particular, for measuring the pressure of the brake fluid, or in an engine, for measuring the oil pressure in said engine.

The operation of the measurement device represented is as follows:

The pins 42 are connected to an electrical power source and/or to an apparatus that needs to receive a pressure measurement.

In the operating position, the fluid surrounding the measurement device penetrates into the interior of the outer chamber 24 through the duct 22. The pressure of this fluid is then exerted on the membrane 16, possibly by means of the glass layer. The gasket 20 prevents this fluid from coming in contact with the support 14 and/or with the electronic component 30 and/or with the flexible connectors, in this instance the springs 40.

Under the effect of a pressure variation of the fluid, the membrane 16, whose peripheral edge is attached on the rim of the cavity 15, bends towards the support 14, inside the cavity, or towards the duct 22, depending on whether the outside pressure is greater than or less than the internal pressure, respectively. This deformation modifies the geometry of the strain gauge fastened to the membrane 16. In FIG. 4, the broken line represents, in an exaggerated manner, the position of the upper surface 16s of the membrane under the effect of an outside pressure greater than the internal pressure. The electric circuit passing through the electronic component 30 and through the strain gauge 33 thus has a behavior that is variable depending on the outside pressure. For example, the electrical resistance of the strain gauge can be modified, which can be reflected in a reduction of the electrical intensity circulating in the electric circuit. The electronic component 30 is configured for bringing about, for example, by means of a model, an evaluation of the outside pressure as a function of the behavior of said electric circuit. This information can be transmitted, through pins 42, to any apparatus, for example, in order to ensure a safety function (for example, in order to deactivate the apparatus in case of excess pressure), or in order to ensure a particular setting, for example, in the context of a control loop.

Under the effect of an increase in the temperature, the length of pin 42 can increase. The springs 40 make it possible to absorb this increase in the length, in such a manner that it does not interact appreciably with the support 14.

As is now clear, a measurement device according to the present invention advantageously enables, at a reduced cost, a measurement of the outside pressure with a limited number of parts. In addition, it enables an operation under very different temperature conditions.

Naturally, the present invention is not limited to the embodiment described and represented, which was provided only as an illustrative example.

1. A device for measuring an outside pressure, comprising:
a pressure sensor comprising a support and a ceramic membrane mounted on the support so as to undergo deformation under the effect of a change in the outside pressure;
a measurement circuit comprising a strain gauge fastened to the ceramic membrane so as to have an electrical property that is variable depending on the position of said membrane; and
an electronic component electrically connected to said strain gauge and configured for processing a signal received from said strain gauge,
wherein the electronic component is fastened to the support.

2. The measurement device according to claim 1, further comprising a connection pin connected to the support by a flexible connector.

3. The measurement device according to claim 2, wherein the flexible connector is selected from a coil spring, a wire or a resilient tongue.

4. The measurement device according to claim 2, wherein that said flexible connector is a coil spring.

5. The measurement device according to claim 2, wherein said flexible connector ensures an electrical connection between said electronic component and said pin.

6. The measurement device according to claim 2, wherein said flexible connector is coated with a gold layer.

7. The measurement device according to claim 6, wherein a nickel sublayer extends between the spring and the gold layer.

8. The measurement device according to claim 1, wherein the support is made of a ceramic material.

9. The measurement device according to claim 1, wherein the pressure sensor comprises a glass layer for insulating said ceramic membrane from the outside.

10. The measurement device according to claim 1, wherein the support and the ceramic membrane together define a leak-proof internal chamber.

11. An apparatus comprising a measurement device according to claim 1, the apparatus being selected from the group consisting of a thermal engine, a transmission, a braking device, an air conditioner, a refrigerator, and a freezer.
